(19) United States
(12) Patent Application Publication
(10) Pub. No.: US 2016/0117652 A1
(43) Pub. Date: Apr. 28, 2016

(54) INFORMATION PROCESSING DEVICE, ELECTRONIC CREDIT INFORMATION COLLECTING SYSTEM, AND ELECTRONIC CREDIT INFORMATION COLLECTING METHOD

(71) Applicants: Hiroyuki MOTOMURA, Tokyo (JP); Akiko YOSHIDA, Tokyo (JP); Ayako SAMUTA, Tokyo (JP)

(72) Inventors: Hiroyuki MOTOMURA, Tokyo (JP); Akiko YOSHIDA, Tokyo (JP); Ayako SAMUTA, Tokyo (JP)

(73) Assignee: RICOH COMPANY, LTD., Tokyo (JP)

(21) Appl. No.: 14/919,908

(22) Filed: Oct. 22, 2015

(30) Foreign Application Priority Data
Oct. 24, 2014 (JP) 2014-217806

(51) Int. Cl. G06Q 20/10

(52) U.S. Cl. CPC G06Q 20/102

(57) ABSTRACT

An information processing device including a determining unit for determining whether a registrant who registers electronic credit information for a provider to an electronic credit server is same as an issuer who issues electronic credit, based on payment information; a comparison unit for comparing the payment information with information stored in a customer master DB while switching a reference destination of the information between a case where the registrant is different from the issuer and a case where the registrant is the same as the issuer, depending on a determination result; a retrieval unit for retrieving, depending on a comparison result, information on the registrant of the electronic credit based on the payment information; and a providing unit for providing, upon determining that the comparison is successful, the information that is retrieved by the retrieval unit as electronic credit collecting information.

### BACKGROUND OF THE INVENTION

1. Field of the Invention

The present invention relates to an information processing device, an electronic credit information collecting system, and an electronic credit information collecting method.

2. Description of the Related Art

Recently, an electronically recorded monetary claims system (which may be referred to as “densai” system, hereinafter) has become available. In the electronically recorded monetary claims system, electronically recorded monetary claims (which may be referred to as “electronic credit,” hereinafter) can be used. In the “densai” system, problems with a paper-based bill and account receivables are attempted to be overcome. By using electronic monetary claims, business operator's financing activities can be smoothed. The “densai” system is a new financial infrastructure that replaces the infrastructure based on a paper-based bill and paper-based account receivables. In the “densai” system, a paper-based bill and paper-based account receivables are digitized, and the digitized bill and digitized account receivables can be provided as electronic credit.

In order to smoothly collect money, a system that is to receive payment by electronic credit can retrieve predetermined information on payment (which is referred to as “payment information,” hereinafter) from the electronic credit that is registered in the “densai” system, and the system can obtain predetermined collection data from the payment information.

A method has been used in the past such that information that is managed by one system is obtained, and the obtained information is used in another system (cf. Patent Document 1 (Japanese Unexamined Patent Publication No. H5-143624) and Patent Document 2 (Japanese Unexamined Patent Publication No. 2009-99070), for example). For example, in Patent Document 1, a method has been disclosed such that order information of a customer is input into an information processing device of the own company, and the order information of the customer is converted into a product code or a unit, based on an order information conversion table at a customer's side. Further, Patent Document 2 discloses a data conversion device that is connected to an integrated business system. The data conversion device is also connected to a plurality of information processing devices. Here, the integrated business system can execute data communication by using a first data format. The information processing devices can execute data communication by using a second data format that is different from the first data format. The data conversion device can convert information that is represented in the first data format and that is received from the integrated business system into information that is represented in the second data format, and the data conversion device can transmit the information that is represented in the second data format to an information processing system.

### SUMMARY OF THE INVENTION

Patent Document 1 does not disclose a method such that information that can be used by a lower-layer system is obtained by applying a process that differs depending on a type of the order information of the customer. Similarly, Patent Document 2 does not disclose a method such that the data conversion device applies, during conversion of the data format, a conversion that differs depending on a type of the data.

An object of an embodiment of the present invention may be to collect predetermined information by using a process that depends on a type of electronic credit.

According to an aspect of the present invention, there is provided an information processing device configured to receive, from an electronic credit server, first payment information that includes electronic credit information, the information processing device including a determining unit configured to determine whether a registrant who registers the electronic credit information for a provider to the electronic credit server is same as an issuer who issues the electronic credit, based on the first payment information that is transmitted from the electronic credit server; a comparison unit configured to compare the first payment information with information that is stored in a customer master DB that stores customer information while switching a reference destination of the information that is stored in the customer master DB between a case in which the registrant is different from the issuer and a case in which the registrant is the same as the issuer, depending on a determination result by the determining unit; a retrieval unit configured to retrieve, depending on a result of a comparison by the comparison unit, information on the registrant of the electronic credit based on the first payment information; and a providing unit configured to provide, upon determining that the comparison by the comparison unit is successful, the information that is retrieved by the retrieval unit as electronic credit collecting information.

According to another aspect of the present invention, there is provided an electronic credit information collecting system including a determining unit configured to determine whether a registrant who registers electronic credit information for a provider to an electronic credit server configured to maintain the electronic credit information is same as an issuer who issues electronic credit, based on payment information including the electronic credit; a comparison unit configured to compare the payment information with information that is stored in a customer master DB that stores customer information while switching a reference destination of the information that is stored in the customer master DB between a case in which the registrant is different from the issuer and a case in which the registrant is the same as the issuer, depending on a determination result by the determining unit; a retrieval unit configured to retrieve, depending on a result of a comparison by the comparison unit, information on the registrant of the electronic credit based on the payment information; and a providing unit configured to provide, upon determining that the comparison by the comparison unit is successful, the information that is retrieved by the retrieval unit as electronic credit collecting information.

According to another aspect of the present invention, there is provided an electronic credit information collecting method that is to be executed by a computer configured to receive payment information including electronic credit information from an electronic credit server, the method including a process, by the computer, of determining whether a registrant who registers the electronic credit information for a provider to the electronic credit server is same as an issuer who issues electronic credit, based on the payment information that is transmitted from the electronic credit server; a process, by the computer, of comparing the payment information with information that is stored in a customer master DB that stores customer information while switching a reference destination of the information that is stored in the customer master DB between a case in which the registrant is different from the issuer and a case in which the registrant is the same as the issuer, depending on the determination result; a process, by the computer, of retrieving, depending on the comparison result, information on the registrant of the electronic credit based on the payment information; and a process, by the computer, of providing, upon determining that the comparison is successful, the information that is retrieved by the process of retrieving as electronic credit collecting information.

According to the embodiment, predetermined information can be collected by a process that depends on a type of the electronic credit.

Other objects, features and advantages of the present invention will become more apparent from the following detailed description when read in conjunction with the accompanying drawings.

### BRIEF DESCRIPTION OF THE DRAWINGS

FIG. 1 is a diagram showing an example of a configuration of an entire electronic credit collecting system according to an embodiment;

FIGS. 2A and 2B are diagrams illustrating a relationship between a registrant of electronic credit and an issuer of the electronic credit according to the embodiment;

FIG. 3 is a diagram showing an example of a functional configuration of an information processing device according to the embodiment and an example of a functional configuration of an electronic credit server according to the embodiment;

FIG. 4 is a diagram showing an example of a payment information DB according to the embodiment;

FIG. 5 is a diagram showing an example of a transaction history information DB according to the embodiment;

FIG. 6 is a diagram showing an example of a customer master DB according to the embodiment;

FIG. 7 is a diagram showing an example of an issuer master DB according to the embodiment;

FIG. 8 is a flowchart illustrating an example of an electronic credit information collecting process according to the embodiment;

FIG. 9 is a diagram illustrating filtering of payment information according to the embodiment;

FIG. 10 is a flowchart illustrating an example of an electronic credit collecting information creating process according to the embodiment;

FIG. 11A is a diagram showing an example of an OK list based on the electronic credit information collecting process according to the embodiment;

FIG. 11B is a diagram showing an example of a NG list based on the electronic credit information collecting process according to the embodiment;

FIG. 12 is a diagram showing an example of a list of provider IDs and information items to be collected according to the embodiment; and

FIG. 13 is a diagram showing an example of a hardware configuration of an information processing device according to the embodiment.

### DETAILED DESCRIPTION OF THE PREFERRED EMBODIMENTS

Hereinafter, an embodiment of the present invention is explained by referring to the accompanying drawings. Note that, in this specification and the drawings, like reference numerals are attached to substantially the same components, and duplicate explanation may be omitted.

[Paper-Based Bill]

Paper-based bills (notes) and paper-based account receivables have been used for commercial transactions. There are two methods of issuing bills, which are a method based on a “self-billing bill” and a method based on “endorsement negotiation.” A bill is a monetary claim that specifies a due date for a customer (which may be referred to as the customer B, for example) to pay money to a provider (which may be referred to as the provider R, for example) who provides a product or a service.

For example, for a case in which a method of issuing a bill is the method based on the “self-billing bill,” the bill may be a bill that is issued by the customer B itself. In this case, the customer B who receives a product or a service from the provider R may be required to pay a price for the product or the service to the provider R by the due date. For the case of the self billing bill, the provider R may request, prior to the due date, a bank to collect the money and the provider R may pay a fee, so that a deposit can be made from a customer B's account to a provider R's account by the due date. For a case in which a method of issuing a bill is the method based on “endorsement negotiation,” the bill may be a bill that is issued by a business partner (which may be referred to as the business partner A, for example) of the customer B. Here, the business partner A receives a product or a service from the customer B. The customer B can use the bill that is collected from the customer B's business partner A for the payment of a debt to the provider R. In this manner, for the case in which the method of issuing the bill is the method based on “endorsement negotiation,” a deposit can be made to the provider R's account by the customer B who receives the product or the service from the provider R by using, for the payment of the debt to the provider R, the bill that is collected from the business partner A.

For the case in which the method of issuing the bill is the method based on “endorsement negotiation,” the provider R may not find information on the business partner A because the customer B's business partner A may not be a business partner of the provider R. For a paper-based bill, the customer B can sign and seal on the back of the bill to indicate that the bill that is to be paid by the business partner A is negotiated (transferred) from the customer B to the provider R. In this manner, a name or the like of the business partner A can be identified by the back of the bill. The above-described process of the paper-based bill can be manually performed.

[Digitization of a Bill]

Recently, paper-based bills and paper-based account receivables have been digitized, and the “densai” system has been available that can provide electronic credit information, instead of the paper-based bills. Hereinafter, there is explained an electronic credit information collecting system 1 for properly collecting electronic credit information from the “densai” system, during commercial transactions for which the “densai” system is used. Note that, in the electronic credit information collecting system 1 according to the embodiment, it is assumed that all the bills are represented by electronic credits, and that no paper-based bill is included. Further, in the electronic credit information collecting system 1 according to the embodiment, it is assumed that a payment amount that is described in an electronic credit can be prorated and transferred.

[Overall Configuration of the Electronic Credit Information Collecting System]

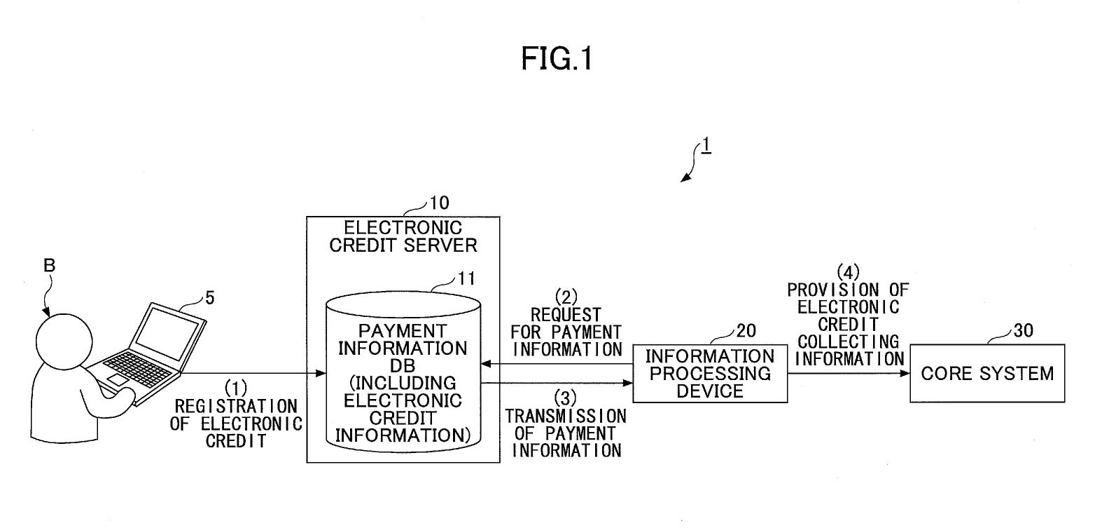

An example of a configuration of the electronic credit information collecting system 1 according to the embodiment is described by referring to FIG. 1. FIG. 1 is a diagram showing an example of the overall configuration of the electronic credit information collecting system 1 according to the embodiment. Here, the term “payment information” can be information on a payment when it is viewed from the side of the “densai” system. The “payment information” may correspond to sales information or accounts receivable information when it is viewed from a side of a provider who collects the electronic credit information (collection data). However, the information can be consistently referred to as the “payment information” below.

The electronic credit information collecting system 1 may include an electronic credit server 10; an information processing device 20; and a core system 30. The electronic credit server 10 and the information processing system 20 can be connected through a network.

In response to receiving a user registration request from a customer, the “densai” system can execute a user registration process for the customer. After completing the user registration process, the customer (e.g., the customer B in FIG. 1) is allowed to register, through a network, electronic credit information to the “densai” system from a personal computer (PC) 5 that is used by the customer (cf. (1) of FIG. 1: registration of electronic credit).

The electronic credit server 10 can be a server for implementing electronic credit business that can be provided by the “densai” system. The electronic credit server 10 can store payment information including electronic credit information that is registered by a customer in a payment information database (DB) 11. During registration of the electronic credit information, the customer can register whether the bill is a bill that is issued by the customer himself/herself (i.e., the self-billing bill), or the bill is a bill to be negotiated (transferred). Based on a type of issuance of the bill that is registered, electronic credit collecting information, which is described below, can be properly collected. Note that a date on which a customer registers electronic credit information can be registered as an electronic recording date, and that the customer can specify, as the date on which the customer registers the electronic credit information, any date up to one month from a date (a notification date) on which the customer makes an application for registration of the electronic credit information.

The information processing device 20 and the core system 30 may be included, for example, in a system of the same company, and the information processing device 20 and the core system 30 may be connected through a dedicated line, such as a local area network (LAN). In the embodiment, the information processing device 20 can function as an intermediary system for providing, to the core system 30, electronic credit information that is included in payment information. Here, the payment information can be received from the electronic credit server 10.

The information processing device 20 can be an example of a computer that can receive, from the electronic credit server 10, payment information that includes electronic credit information. The information processing device 20 can convert the data that is received from the electronic credit server 10 into data that can be processed by the core system 30. The information processing device 20 can examine the data that is received from the electronic credit server 10. For example, the information processing device 20 can examine a coding scheme of the received data. Upon determining, as a result of the examination of the received data, that a failure can be caused if the data that is received from the electronic credit server 10 is transmitted as it is to the core system 30, the information processing device 20 can covert the received data into data that can be processed by the core system 30, and the information processing device 20 can transmit the converted data to the core system 30. In this manner, the information processing device 20 can allow the information, which is a part of the electronic credit information that is retrieved from the electronic credit server 10 and that is desired to be used by the core system 30, to be used by the core system 30 without requiring any modification to the core system 30. The information processing device 20 can be implemented by an electronic device, such as a personal computer (PC).

[Registrant and Issuer of Electronic Credit]

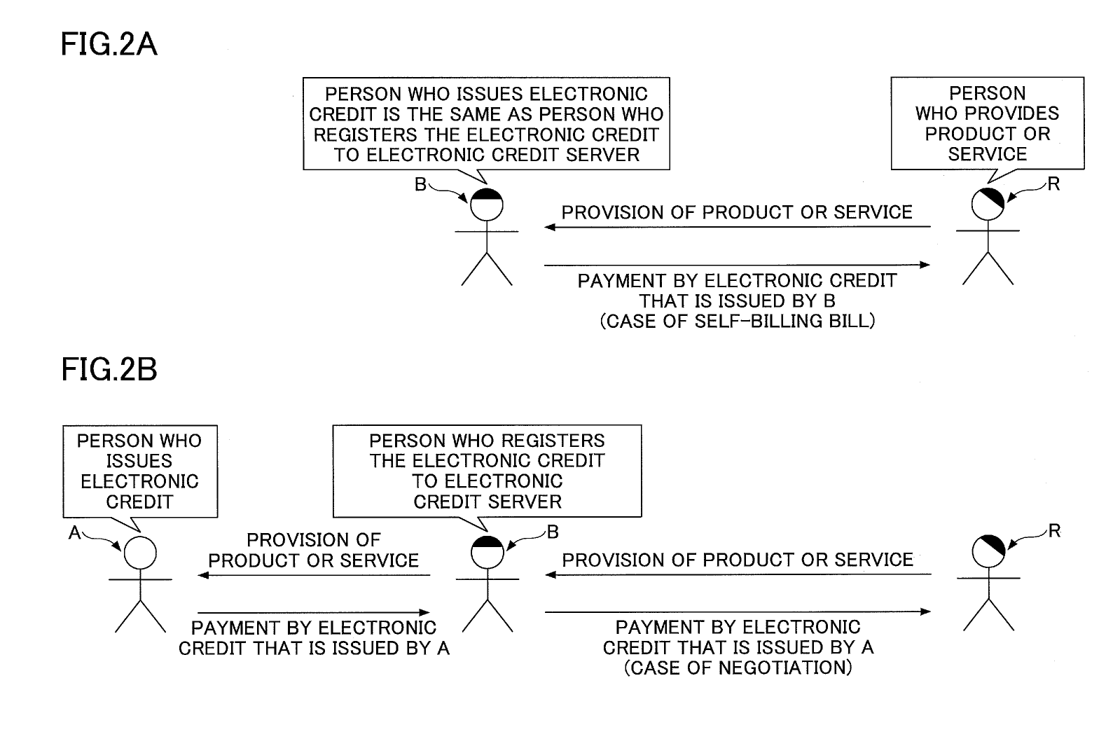

Before describing details of the electronic credit information collecting system 1 according to the embodiment, a concept of a registrant of the electronic credit and a concept of an issuer of the electronic credit are described by referring to FIGS. 2A and 2B. FIGS. 2A and 2B are diagrams illustrating a relationship between the registrant and the issuer of the electronic credit according to the embodiment. FIG. 2A shows a case in which the registrant of the electronic credit is the same as the issuer of the electronic credit. FIG. 2B shows a case in which the registrant of the electronic credit is different from the issuer of the electronic credit.

First, the case of FIG. 2A is described in which the registrant of the electronic credit is the same as the issuer of the electronic credit. FIG. 2A can be an example in which the above-described paper-based self-billing bill is applied to electronic credit. A provider (which may be referred to as the “provider R,” hereinafter) is a person who can provide a product or a service to a registrant (which may be referred to as the “registrant B,” hereinafter). The registrant B can be a person who can receive the product or a service from the provider R. The registrant B can be a customer of the provider R. Further, the registrant B can be a person who registers, to the electronic credit server 10, the electronic credit information that is for the payment to the provider R. In the electronic credit system, a deposit can be made, through the “densai” system, from an account of the registrant B to an account of the provider R on the due date of the payment.

The registrant B can be an issuer who issues payment information with respect to the provider R. Namely, the registrant B can be an issuer who issues the electronic credit. In this case, the registrant of the electronic credit and the issuer of the electronic credit can be the same customer B.

Next, the case of FIG. 2B is described in which the registrant of the electronic credit is different from the issuer of the electronic credit. FIG. 2B can be an example in which the above-described paper-based bill that is to be endorsed and negotiated is applied to electronic credit. In the electronic credit system, the bill that is to be endorsed and negotiated may be simply referred to as a negotiable bill. The provider R can be a person who can provide a product or a service to a registrant B. The registrant B can be a person who can receive the product or a service from the provider R. The registrant B can be a customer of the provider R.

At the same time, the registrant B can be a person who can provide a product or a service to a business partner A of the registrant B (i.e., a customer of the registrant B). Namely, in the relationship with the business partner A, the registrant B can be a provider, and the business partner A can be a person who can receive a product or a service from the registrant B, that is, the business partner A can be a registrant B's customer.

At the same time, the business partner A can be an issuer who issues electronic credit to the registrant B. The customer B can use a bill that is collected from the customer B's business partner A for a payment of a debt to the provider R. In this manner, for the case of the negotiable bill, the registrant B who can receive a product or a service from the provider R can use the bill that is collected from the business partner A for the payment of the debt to the provider R. In this case, the registrant of the electronic credit is different from the issuer of the electronic credit.

[Functional Configuration]

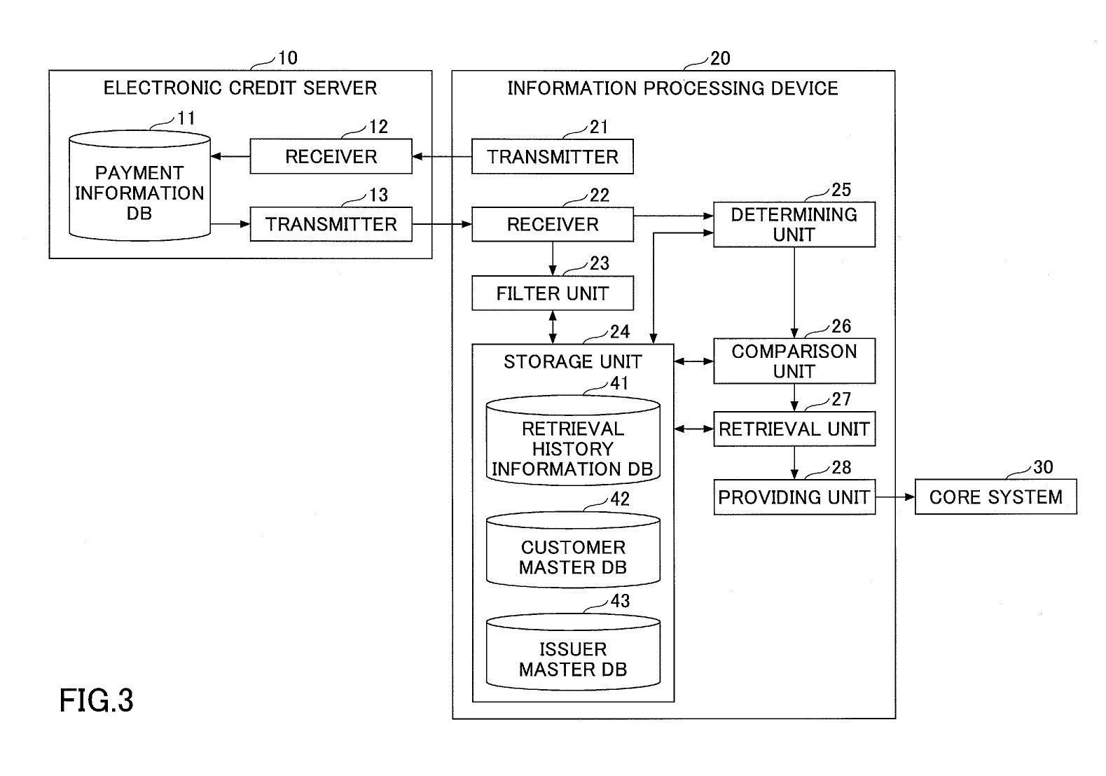

Next, an example a functional configuration of the electronic credit information collecting system 1 according to the embodiment is described by referring to FIG. 3. FIG. 3 is a diagram showing an example of a functional configuration of the electronic credit server 10 and an example of a functional configuration of the information processing device 20.

(Electronic Credit Server)

The electronic credit server 10 may include a receiver 12; and a transmitter 13. In addition, the electronic credit server 10 may store and maintain the payment information database (DB) 11. The receiver 12 can receive a retrieval request for retrieving payment information (which includes electronic credit). The retrieval request can be transmitted from the information processing device 20 (cf. (2) request for payment information of FIG. 1).

In response to receiving, from the information processing device 20, the retrieval request for retrieving the payment information, the transmitter 13 can transmit predetermined payment information that can be retrieved from the payment information DB 11 (cf. (3) transmission of payment information of FIG. 1).

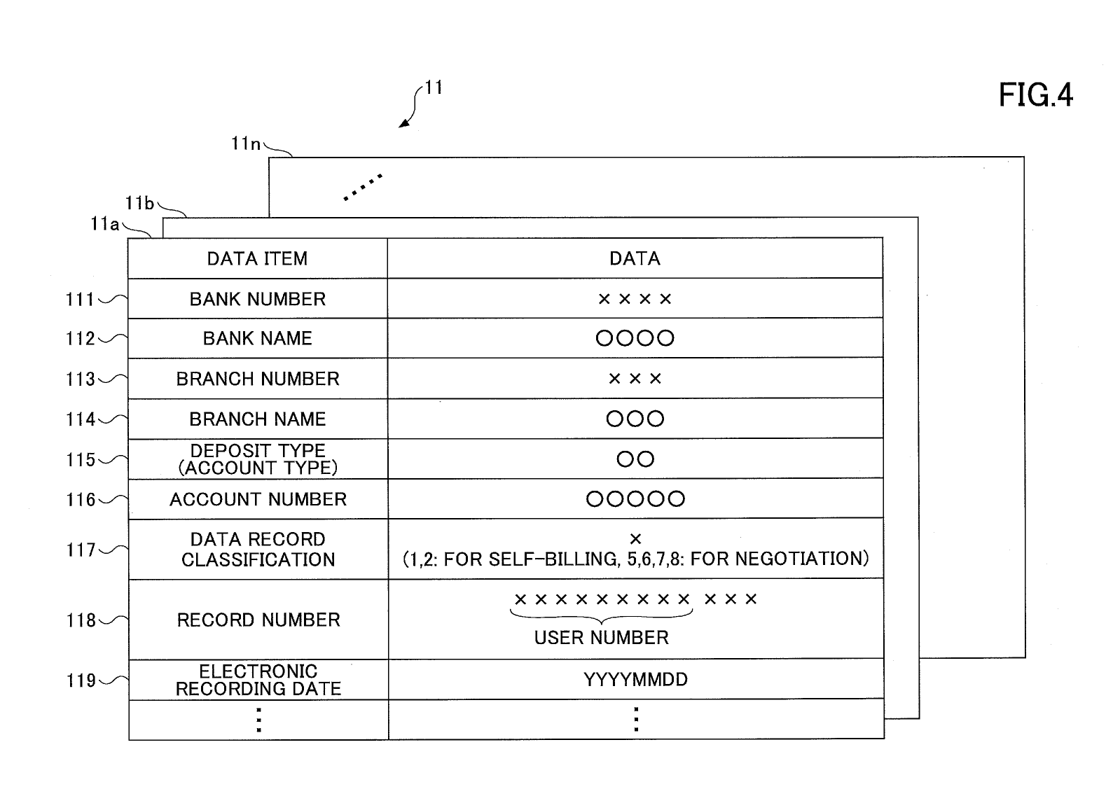

As shown in FIG. 4, in the payment information DB 11, payment information 11a, payment information 11b, . . . , and payment information 11n can be stored that correspond to items of registered electronic credit. As for data items of each of the payment information 11a, the payment information 11b, . . . , and the payment information 11n, a bank number 111; a bank name 112; a branch number 113; a branch name 114; a deposit type (account type) 115; an account number 116; a data record classification 117; a record number 118; and an electronic recording date 119 can be set. However, data items that can be stored in the payment information DB 11 are not limited to these.

In the payment information DB 11, for each of the data items, corresponding data can be set. For example, if “1” or “2” is set to the data record classification 117, it is indicated that the type of issuance of the electronic credit information that is included in the payment information is “self-billing.” Further, for example, if “5,” “6,” “7,” or “8” is set to the data record classification 117, it is indicated that the type of issuance of the electronic credit information that is included in the payment information is “negotiation.”

The record number 118 can be a number for identifying each of the payment information 11a, the payment information 11b, . . . , and the payment information 11n. Namely, the record number 118 can be a number for identifying each electronic credit that is registered to the electronic credit server 10. The top nine digits of the record number 118 can be a user number. The user number can be an identification number for identifying a user such that, among the users who use the “densai” system, one user number can be assigned to one company.

(Information Processing Device)

The information processing device 20 may include a transmitter 21; a receiver 22; a filter unit 23; a storage unit 24; a determining unit 25; a comparison unit 26; a retrieval unit 27; and a providing unit 28.

The transmitter 21 can transmit a retrieval request for retrieving payment information. The receiver 22 can receive predetermined payment information that can be transmitted from the electronic credit server 10.

The filter unit 23 can remove (execute filtering of) payment information that may not be a target of retrieval from the payment information that can be transmitted from the electronic payment server 10 by comparing the electronic recording date 119 that can be specified by a registrant with the current date. Payment information other than the payment information that can be processed on the current date may be the payment information that may not be the target of retrieval. Further, payment information having a cancellation classification of “1” can be payment information that can be cancelled. Thus, the payment information having the cancellation classification of “1” may not be the target of retrieval.

Additionally, the filter unit 23 can remove (execute filtering of), from the payment information that can be transmitted from the electronic credit server 10, payment information that overlaps the payment information that can be stored in a retrieval history information database (DB) 41. In this manner, the payment information that can be a remainder of the payment information that can be transmitted from the electronic credit server 10 can be retrieved. Here, the remainder of the payment information that can be transmitted from the electronic credit server 10 can be formed by removing the payment information that may not be the target of retrieval from the payment information that can be transmitted from the electronic credit server 10.

The storage unit 24 can store and maintain the retrieval history information DB 41; a customer master database (DB) 42; and an issuer master database (DB) 43. The storage unit 24 can store, in the retrieval history information DB 41, the remainder of the payment information that can be transmitted from the electronic credit server 10. As described above, the remainder of the payment information that can be transmitted from the electronic credit server 10 can be formed by removing the payment information that may not be the target of retrieval from the payment information that can be transmitted from the electronic credit server 10.

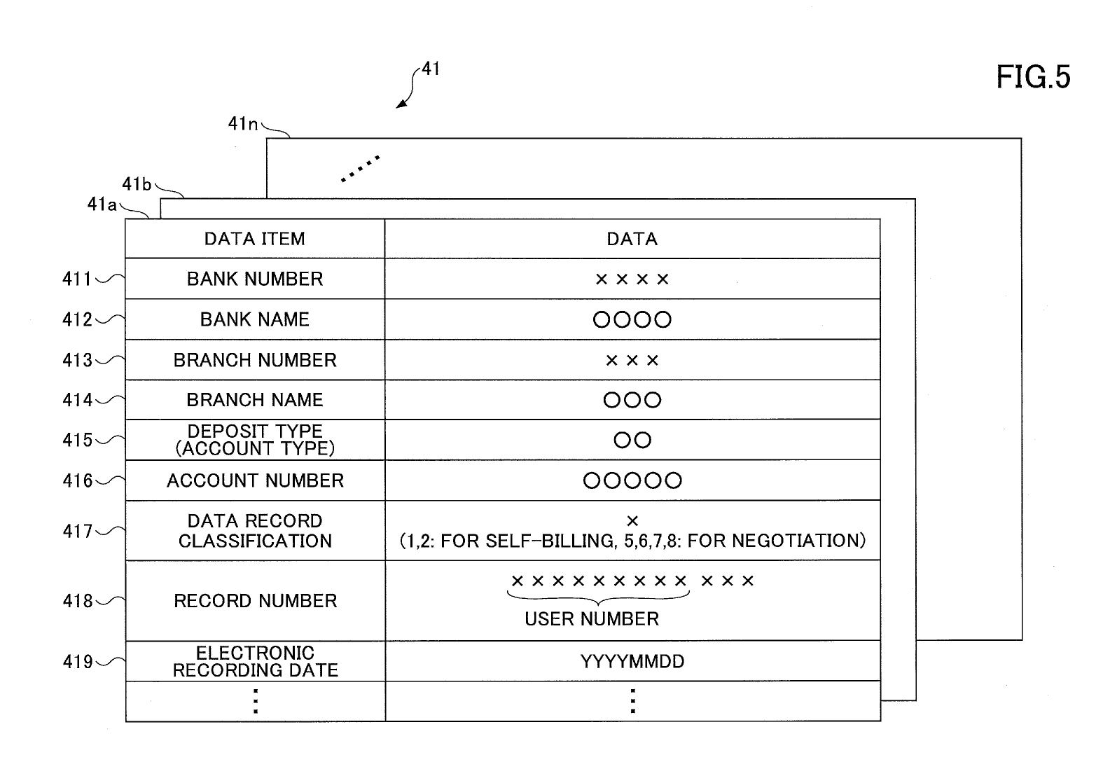

As shown in FIG. 5, the retrieval history information DB 41 can store the remainder of the payment information that can be transmitted from the electronic credit server 10 (i.e., the payment information that can be transmitted from the electronic credit server 10 and that is not removed by the filter unit 23) as retrieval history information 41a, retrieval history information 41b, . . . , and retrieval history information 41n, for example. Namely, the retrieval history information DB 41 can indicate history information of the payment information that is retrieved by the information processing device 20. Consequently, data items 411 to 419 of the retrieval history information DB 41 can be the same as the data items 111 to 119 of the payment information DB 11 that are shown in FIG. 4. However, the retrieval history information DB 41 may not include the removed payment information that is removed from the payment information 11a, the payment information 11b, . . . , and the payment information 11n.

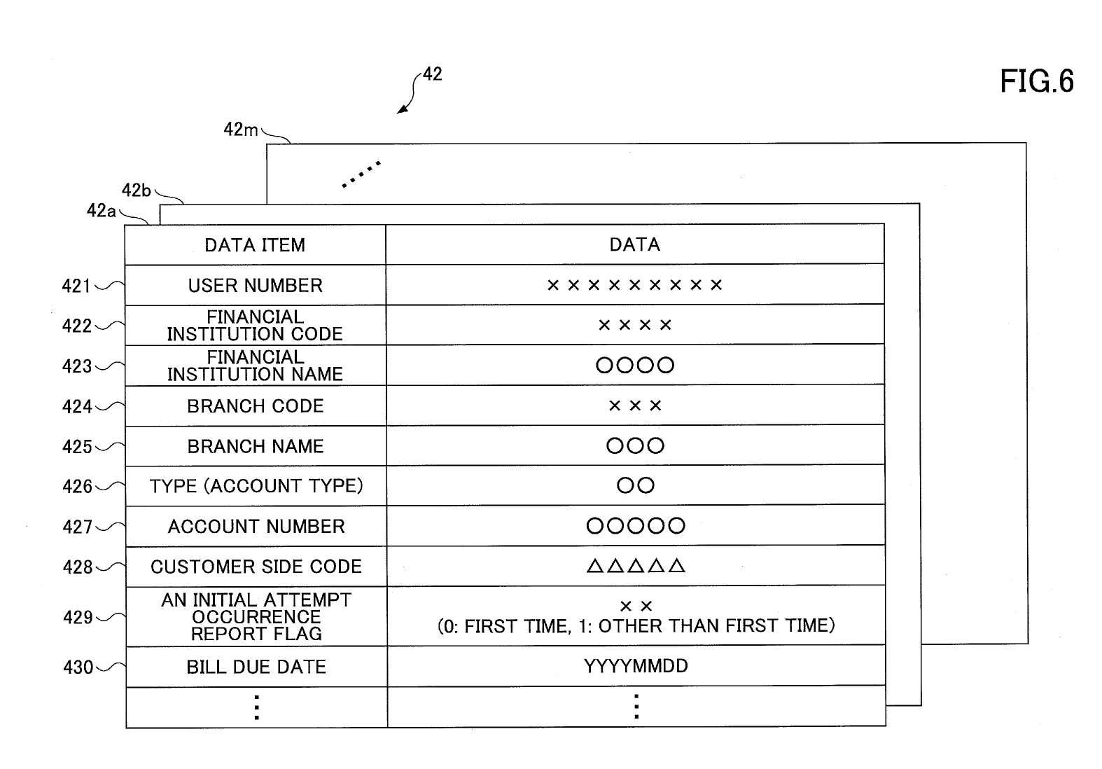

As shown in FIG. 6, the customer master DB 42 shows an example of customer master information that can be stored for each of customers (registrants) of the “densai” system. For example, the customer master DB 42 can store customer master information 42a, customer master information 42b, and customer master information 42m. As data items of each of the customer master information 42a, the customer master information 42b, . . . , and the customer master information 42m, a user number 421; a financial institution code 422; a financial institution name 423; a branch code 424; a branch name 425; a type (account type) 426; an account number 427; a customer site code 428; an initial attempt occurrence report flag 429; and a bill due date 430 can be set, for example. Note that the customer master information that can be stored in the customer master DB 42 is not limited to these.

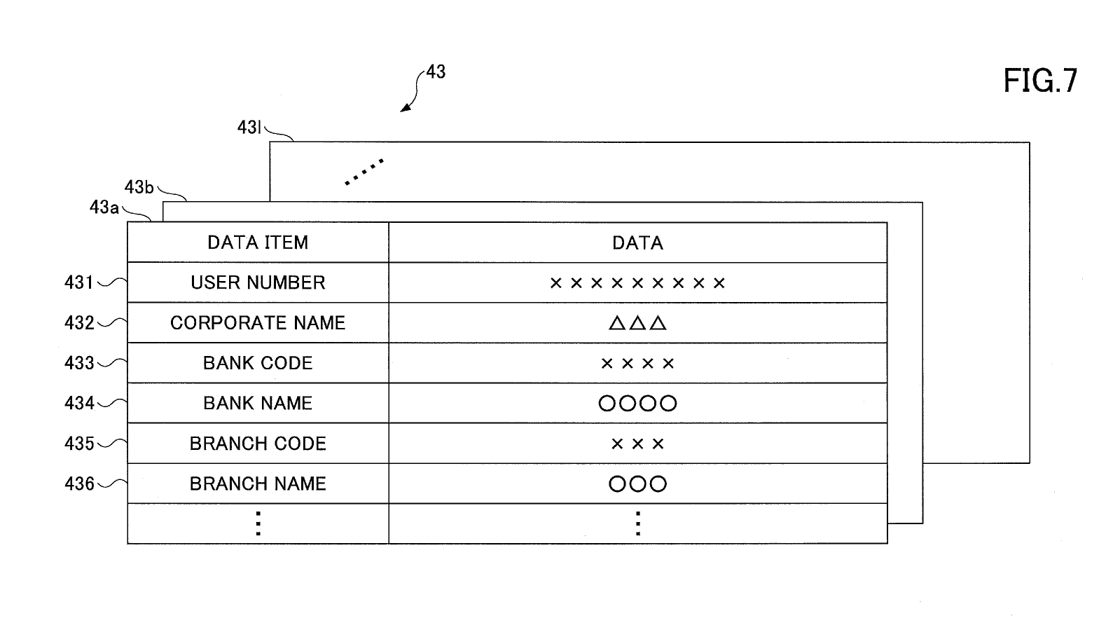

As shown in FIG. 7, the issuer master DB 43 shows an example of issuer master information that can be stored for each of issuers of electronic credit for “negotiation.” The issuer master information may correspond to information on an issuer that can be described on a back of a paper-based bill that is to be endorsed and negotiated.

For example, the issuer master DB 43 can store master information 43a, master information 43b, . . . , and master information 431 for the corresponding issuers. As data items of each of the master information 43a, the master information 43b, . . . , and the master information 431 for the corresponding issuers, a user number 431; a corporate name 432; a bank code 433; a bank name 434; a branch code 435; and a branch name 436 can be set, for example. Note that the issuer master information that can be stored in the issuer master DB 43 is not limited to the above-described information items.

The determining unit 25 can determine whether a registrant who registers, to the electronic credit server 10, electronic credit information with respect to a provider is the same as an issuer who issues the electronic credit, based on payment information that is received by the receiver 22.

Specifically, in response to detecting that the data record classification 117 of the payment information DB 11 of FIG. 4 is “1” or “2,” the determining unit 25 can determine that the registrant who registers the electronic credit to the electronic credit server 10 is the same as the issuer who issues the electronic credit. Whereas, in response to detecting that the data record classification 117 is “5,” “6,” “7,” or “8,” the determining unit 25 can determine that the registrant who registers the electronic credit to the electronic credit server 10 is not the same as the issuer who issues the electronic credit.

The comparison unit 26 can compare the customer master information that is stored in the customer master DB 42 with payment information, depending on a result of the determination by the determining unit 25. Specifically, in response to determining, by the determining unit 25, that the registrant is the same as the issuer, the comparison unit 26 can compare the user number 421 that is stored in the customer master DB 42 storing the information on the registrant with the number that is the top nine digits of the record number 118 of the payment information (an example of the identification information of the user).

Further, in response to determining, by the determining unit 25, that the registrant is not the same as the issuer, the comparison unit 26 can compare the financial institution code 422, the branch code 424, the type (the account type) 426, and the account number 427 that are stored in the customer master DB 42 with the bank number 111, the branch number 113, the deposit type (the account type) 115, and the account number 116 of the payment information.

Depending on a result of the comparison by the comparison unit 26, the retrieval unit 27 can retrieve, based on the payment information, the information on the registrant who registers the electronic credit.

The providing unit 28 can provide the information that is retrieved by the retrieval unit 27 as the electronic credit collecting information (cf. (4) of FIG. 1: provision of electronic credit collecting information). Upon determining that the compared payment information is first electronic credit, by using the “densai” system, of the user who is identified by the user number 421, the providing unit 28 can transmit a report indicating that the electronic credit is for an electronic credit transaction for the first time of the user. Additionally, for the compared payment information, the providing unit 29 can transmit a report on an error in the bill due date 430 (which is explained below), for example.

[Electronic Credit Information Collecting Process]

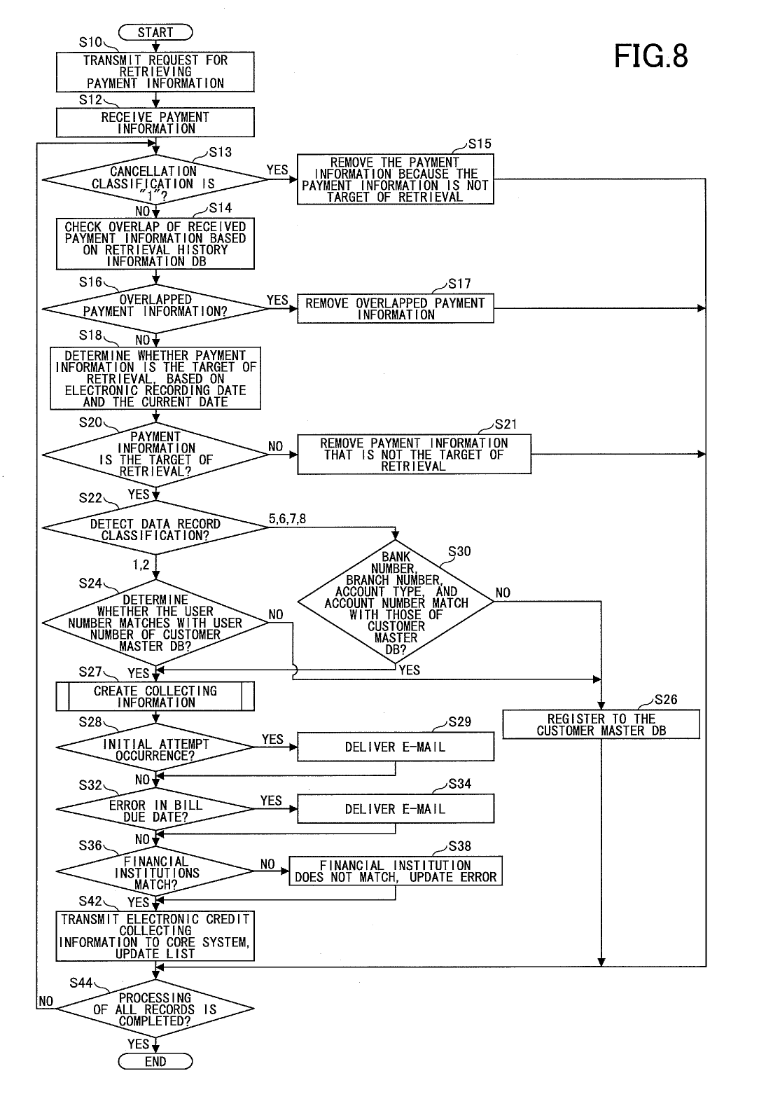

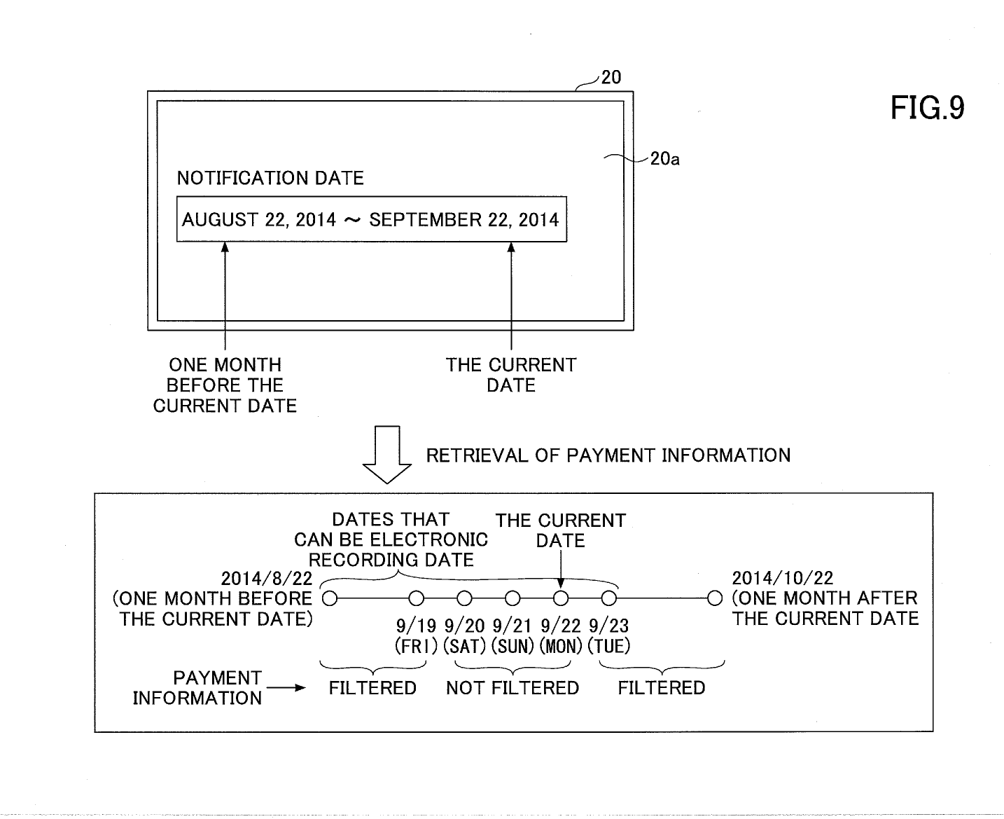

Next, an electronic credit information collecting process according to the embodiment is explained by referring to FIG. 8. FIG. 8 is a flowchart illustrating an example of the electronic credit information collecting process according to the embodiment. First, the transmitter 21 of the information processing device 20 transmits a retrieval request for retrieving payment information (electronic credit) (step S10). Specifically, as shown in FIG. 9, in response to specifying a range of a notification date on a Web screen 20a that is displayed on the information processing device 20, the transmitter 21 transmits the retrieval request for retrieving payment information within the range of the notification date. The notification date can be a date on which a registrant of the electronic credit makes a registration of the electronic credit to the “densai” system, and the notification date may be different from an electronic recording date of the electronic credit. The notification data can be the date on which the registration of the electronic credit to the “densai” system is made. Upon completing the registration, a notification for notifying that the registration of the electronic credit is completed is transmitted to a payee. During the registration, by the registrant, of the electronic credit to the electronic credit server 10, the registrant can create data of electronic recording dates (reservation data) up to one month ahead of the notification date by using a reservation request function. An electronic recording date can be a date on which electronic credit becomes effective, and the electronic recording date can be a date of collecting the credit. Namely, with respect to the notification date of the electronic credit, any date from the notification date to one month ahead of the notification date can be specified as an electronic recording date. In the embodiment, a range from one month ago to the current date can be specified as the range of the notification date.

Thus, as shown in FIG. 9, upon inputting the notification date for which the electronic recording date can be the current date into a notification date field, a range that is from the date that is one month before the current date (i.e., Aug. 22, 2014) to the current date (i.e., Sep. 22, 2014) can be specified as the range of the notification date. In this manner, the payment information that includes all the payment information that is to be processed today can be received from the electronic credit server 10.

Referring to FIG. 8, the receiver 22 of the information processing device 20 receives payment information that corresponds to the retrieval request for retrieving payment information (step S12). Next, the filter unit 23 determines whether a cancellation classification of the received payment information is “1” (step S13). Upon determining that the cancellation classification is “1,” the filter unit 23 determines that the payment information may not be a target of retrieval because the payment information is cancelled. Then, the filter unit 23 removes the payment information (step S15), and the process proceeds to step S44. Upon determining, by the filter unit 23, that the cancellation classification is not “1,” the process proceeds to step S14.

Next, the filter unit 23 executes an overlap checking process for determining whether the received payment information includes the payment information that is already stored in the retrieval history information DB 41 (step S14). Upon determining that the record number 118 of the received payment information matches with the record number 418 of the payment information that is stored in the retrieval history information DB 41, the filter unit 23 determines that the received payment information is the payment information that is already stored in the retrieval history information DB 41.

Upon determining that the received payment information includes the payment information that is already stored in the retrieval history information DB 41, the filter unit 23 removes the payment information that is included in the received payment information and that is already stored in the retrieval history information DB 41 so as to avoid that the payment information that is already stored in the retrieval history information DB 41 is stored again (step S17). Then, the process proceeds to step S44.

For example, for a case of receiving the payment information from the electronic credit server 10 multiple times on the same day, the payment information that is received for the first time may overlap the payment information that is received later. In this case, the payment information that is already stored can be prevented from being stored again by using the filter unit 23.

Next, for the remainder of the payment information that is obtained by removing, from the payment information that is received from the electronic credit server 10, the payment information that is already stored in the retrieval history information DB 41, the filter unit 23 determines whether the payment information is the target of retrieval, based on the electronic recording date 119 and the current date (step S18). Upon determining, based on the electronic recording date 119 and the current date, that the payment information is not the target of retrieval (No at step S20), the filter unit 23 removes the payment information that is determined not to be the target of retrieval (step S21). Then, the process proceeds to step S44.

The electronic recording date 19 can be a date on which electronic credit becomes effective. The payment information that can be a target of retrieval is payment information such that the electronic recording date 119 of the payment information is the same as the current date, or the payment information that can be a target of retrieval is payment information that is not retrieved on a date that is before the current date. Thus, the payment information of which the electronic recording date 119 is before the current date is to be removed in principle because the payment is already made for such payment information. In addition, the payment information of which the electronic recording date 119 is after the current date is to be removed in principle because the payment information is not effective yet. As shown in FIG. 9, if the notification date is set to be a date between the current date and one month before the current date, the electronic recording date 119 of the retrieved payment information can be a date between one month before the current date and one month after the current date. Thus, the payment information of which the electronic recording date 119 is the same as the current date of September 22 (Monday) can be the target of the retrieval. Further, even if the electronic recording date 19 of the payment information is before the current date, if the electronic recording date 19 of the payment information is September 20 (Saturday) or September (Sunday) (note that September 20 (Saturday) and September 21 (Sunday) are not business days), the payment information is not retrieved yet, as of September 22 (Monday). Consequently, the payment information of which the electronic recording date 19 is from September 20 (Saturday) to September 22 (Monday) can be the target of retrieval, and the payment information may not be filtered. Whereas, the payment information of which the electronic recording date 19 is before September 20 (Saturday) and the payment information of which the electronic recording date 19 is after September 22 (Monday) may not the target of retrieval, so that the payment information can be removed. However, the payment information that is not yet retrieved can be the target of retrieval. The removed payment information can be output as a list or can be displayed on a screen so as to indicate that the payment information is removed. At this time, the number of the removed payment information items and the details of the contents of the removed payment information items can be output or displayed.

Referring to FIG. 8, subsequently, the determining unit 25 detects the data record classification 117 of the payment information (step S22). The data record classification 117 can be classified into (1) a case of a “self-billing bill” (data record classification: 1 or 2), and (2) a case of a “negotiable bill” (data record classification: 5, 6, 7, or 8).

Upon determining that the data record classification 117 is “1” or “2,” the determining unit 25 determines that a type of issuing the electronic credit of the payment information is a “self-billing bill.” In this case, the determining unit 25 determines whether the user number that is indicated by the top nine digits of the record number 118 of the payment information matches with one of the user numbers 421 of the customer master DB 42 (step S24). In response to determining, by the determining unit 25, that there is no user number in the customer master DB 42 that matches with the user number that is indicated by the top nine digits of the record number 118 of the payment information, the storage unit 24 registers predetermined information of the payment information to the customer master DB 42 (step S26). Then, the process proceeds to step S44. Whereas, in response to determining, by the determining unit 25, that there is a user number 421 in the customer master DB 42 that matches with the user number that is indicated by the top nine digits of the record number 118, the process proceeds to step S27.

In response to detecting that the data record classification 117 is “5,” “6,” “7,” or “8,” the determining unit 25 determines that a type of issuing the electronic credit of the payment information is a “negotiable bill.” The determining unit 25 determines whether the bank number 111, the branch number 113, the deposit type (the account type) 115, and the account number 116 of the payment information match with the financial institution code 422, the branch code 424, the type (the account type) 426, and the account number 427 that are stored in the customer master DB 42 (step S30).

In response to determining, by the determining unit 25, that the customer master DB 42 does not store the financial institution code 422, the branch code 424, the type (the account type) 426, and the account number 427 that match with the bank number 111, the branch number 113, the deposit type (the account type) 115, and the account number 116 of the payment information, the storage unit 24 registers predetermined information of the payment information to the customer master DB 42 (step S26). Then, the process proceeds to step S44. Whereas, in response to determining, by the determining unit 25, that the customer master DB 42 stores the financial institution code 422, the branch code 424, the type (the account type) 426, and the account number 427 that match with the bank number 111, the branch number 113, the deposit type (the account type) 115, and the account number 116 of the payment information, the process proceeds to step S27.

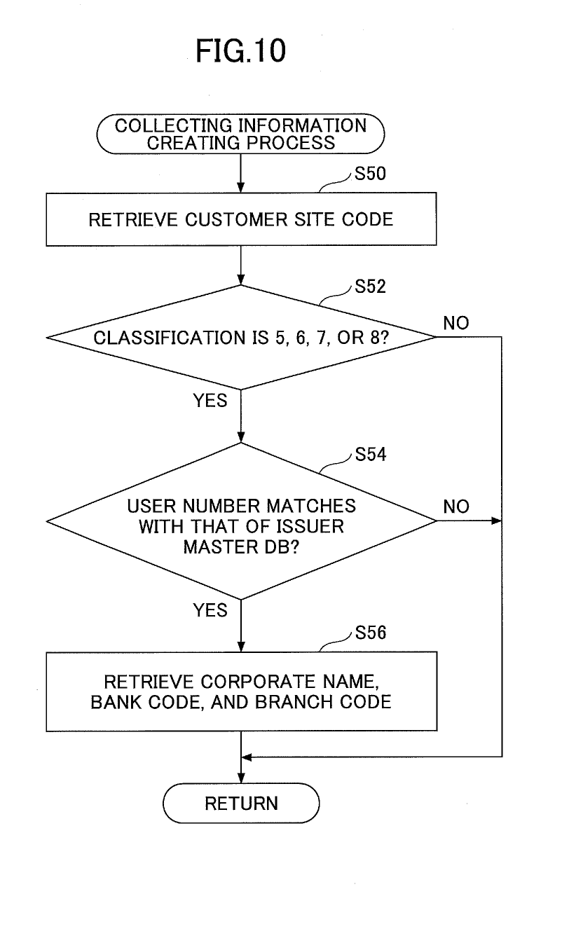

Next, a collecting information creating process is executed (step S27). FIG. 10 is a flowchart illustrating an example of the collecting information creating process.

In the collecting information creating process of FIG. 10, first, the information processing device 20 collects necessary information, for example, from the payment information that is received from the “densai” system. For example, the retrieval unit 27 can collect necessary information, such as the customer site code 428 of the customer master DB 42 (step S50). The customer site code 428 can be information on the registrant for both electronic credit of a “self-billing bill” and electronic credit of a “negotiable bill.”

Next, the information processing device 20 creates data based on the collected information, and the information processing device 20 provides, as collected data, the created data to the core system 30. Alternatively, the core system 30 retrieves the collected data. For example, the determining unit 25 of the information processing device 20 determines whether the data record classification 117 is “5,” “6,” “7,” or “8” (step S52). In response to determining, by the determining unit 25, that the data record classification 117 is not “5,” “6,” “7,” and “8,” the process is terminated. Whereas, in response to determining that the data record classification 117 is “5,” “6,” “7,” or “8,” the determining unit 25 determines whether the user number 431 of the issuer master DB 43 matches with the user number that is the top nine digits of the record number 118 of the payment information (step S54). In response to determining that the user number 431 of the issuer master DB 43 matches with the user number that is the top nine digits of the record number 118 of the payment information, the retrieval unit 27 retrieves the corporate name 432, the bank code 433, and the branch code 435 (step S56), and the process is terminated. In response to determining that the user number 431 of the issuer master DB 43 does not match with the user number that is the top nine digits of the record number 118 of the payment information, the process is terminated.

Note that, in addition to the corporate name 432, the bank code 433, and the branch code 435, the retrieval unit 27 may retrieve the bank name 434, and the branch name 436. Further, for a case of a “negotiable bill,” if the information on the issuer is not required, the process from step S52 to step S56 can be omitted. The providing unit 28 creates the collected data that is formed by including the retrieved customer site code 428, and an amount of money, a due date, a place of payment (bank), a place of payment (branch), an issue date, and an issuer of a bill of the payment information in the electronic credit collecting information. In addition, if the issuer master DB 43 exists, the providing unit 28 may create the collected data such that “the corporate name,” “the bank code,” and “the branch code” are further set to “the issuer of the bill,” “the place of payment (bank),” and “the place of payment (branch),” respectively, and that “the corporate name,” “the bank code,” and “the branch code” are included in the collected data. For example, the corporate name 432 may be information on an issuer of a “negotiable bill.” The collected data may be transmitted to the core system 30 by the providing unit 28. Alternatively, the core system 30 may retrieve the collected data.

Referring to FIG. 8, subsequently, the comparison unit 26 determines, at step S28, whether the payment information is for a first electronic credit transaction (which may be referred to as an initial attempt occurrence, hereinafter) of the user who is identified by the use number. Upon determining that the initial attempt occurrence report flag 429 of the customer master DB 42 is “0,” the comparison unit 26 determines that the payment information is for first bill processing by using the electronic credit of the user who is identified by the user number. The transmitter 21 automatically delivers, for the electronic credit that is determined to be the initial attempt occurrence, an e-mail for informing that the paper-based bill is switched to the bill processing by the electronic credit by using the “densai” system (step S29). The e-mail can be delivered to a contact address of a sales representative and a contact address of a business person in charge. After transmitting the e-mail, the comparison unit 26 sets the initial attempt occurrence report flag 429 to “1.” By doing this, the above-described e-mail may not be delivered, even if the subsequent bill processing by the electronic credit occurs.

Subsequently, the comparison unit 26 determines whether a difference in date between the bill due date 430 that is stored in the customer master DB 42 and the electronic recording date 119 that is stored in the payment information DB 11 is greater than or equal to five days (step S32). The bill due date 430 can specify a due date of a bill. In response to determining, as a result of the comparison by the comparison unit 26, that the difference in date between the bill due date 430 and the electronic recording date 119 is greater than or equal to five days, the transmitter 21 automatically delivers an e-mail for prompting confirmation of the due date of the bill (step S34). The e-mail can be delivered to a contact address of a sales representative and a contact address of a business person in charge.

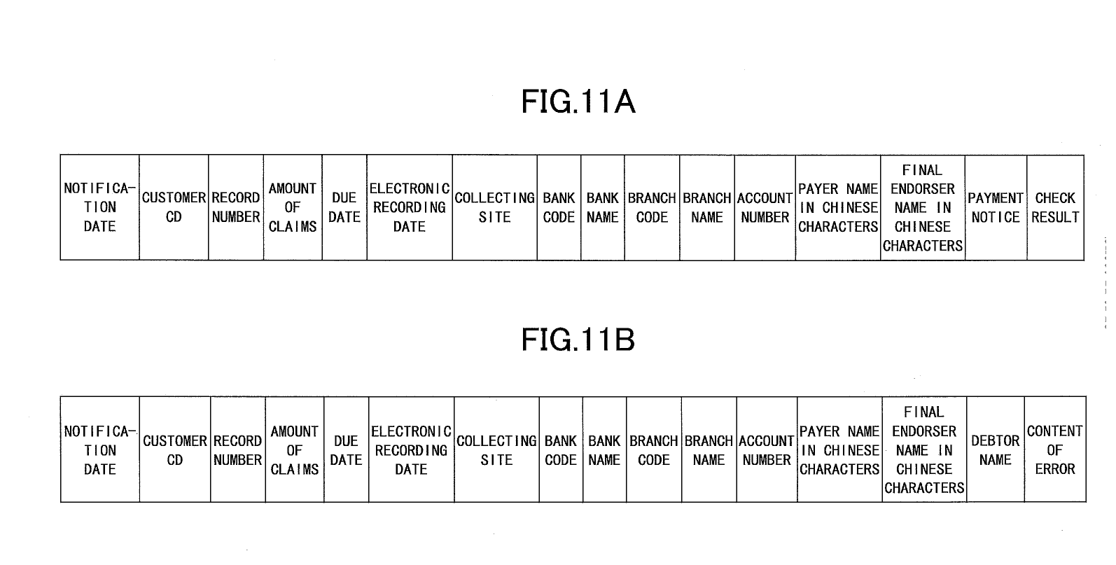

Next, the comparison unit 26 determines whether the information on the financial institution (i.e., the financial institution code 422, the branch code 424, the type 426, and the account number 427) that is stored in the customer master DB 42 matches with the bank information (i.e., the bank number 111, the branch number 113, the deposit type 115, and the account number 116) that is stored in the payment information DB 11 (step S36). In response to determining that the information on the financial institution that is stored in the customer master DB 42 does not match with the bank information that is stored in the payment information DB 11, the storage unit 24 stores, in a field of a determination result of the “OK list” that is shown in FIG. 11A, information indicating that the information on the financial institution that is stored in the customer master DB 42 does not match with the bank information that is stored in the payment information DB 11 (step S38).

Next, the providing unit 28 transmits the created electronic credit collecting information to the core system 30. As an example of transmission timing, the electronic credit collecting information can be transmitted to the core system 30 once per hour.

Further, the providing unit 28 updates the “OK list” of FIG. 11A and a “NG list” of FIG. 11B.

As an example of updating the “NG list,” in response to an occurrence of a matching error in the electronic credit information collecting process of FIG. 8, a list of data items that fail to match can be created and output. Based on the “NG list,” the comparison unit 26 can correct an error portion of the payment information that fails to match. For the corrected payment information, the process from step S22 is executed again.

Note that the following data items can be considered as an example of data items that can be output to the “NG list” of FIG. 11B. However, the items (1) to (3) are for exemplifying purposes only, and the data items that can be output to the “NG list” are not limited to these.

(1) Upon determining, in the process of comparison of the issuer master DB 43 of FIG. 10, that matching fails, “no issuer” is output to a field of a description of an error in the “NG list.”

(2) Upon determining, in each checking process of FIG. 8, that no key is detected that matches with the set key, “no registration” is output to the field of the description of the error in the “NG list.”

(3) Upon determining that a status of payment information that is a target of retrieval indicates that the registration is not completed, “registration is not completed” is output to the field of the description of the errors in the “NG list.”

As an example of data items that can be output to the “OK list” of FIG. 11A, the following data items can be considered. However, the following data items (1) and (2) are for exemplifying purposes only, and the data items that can be output to the “OK list” are not limited to these. The “OK list” is a list of data items whose matching results are “OK.” Accordingly, the corresponding payment information is effective, and the payment information is the target of retrieval.

(1) Output an explanation of a payment notice to the “OK list.” If, in the customer master DB 42, a payment breakdown document is registered with “1 (issue),” a payment notice is required. Thus, a circle mark is input to a field of a payment notice of the “OK list.”

(2) Output an explanation of a result of checking to the “OK list.” If it turns out that the result of comparing the customer DB 42 with the retrieved payment information is an error, a “collection site” and “bank information” of the payment information that is turned out to be an error are displayed.

Next, the determining unit 25 determines whether processing of all the records of payment information that are the target of retrieval is completed (step S44). Upon determining, by the determining unit 25, that processing of all the records is not completed, the process returns to step S13. Upon determining, by the determining unit 25, that processing of all the records is completed, the process is terminated. The collected data that is created in this manner can be transmitted to the core system 30 by the providing unit 28. Alternatively, the core system 30 may retrieve the collected data. Namely, the collected data that is formed by including, in the electronic credit collecting information, the customer site code 428, and “the amount of money,” “the due date,” “the place of payment (bank),” “the place of payment (branch),” “the issue date,” and “the issuer of the bill” of the payment information can be provided to the core system 30 as collection data. If the issuer master DB 43 exists, “the corporate name,” “the bank code,” and “the branch code” can further be set to “the issuer of the bill,” “the place of payment (bank),” and “the place of payment (branch),” respectively, and the collected data that includes “the corporate name,” “the bank code,” and “the branch code” can be provided to the core system 30 as the collection data.

As described above, in the electronic credit information collecting system 1 according to the embodiment, by a process that depends on a type of electronic credit, predetermined information can be collected. Namely, during a process of collecting information by the core system 30, proper information on the electronic credit can be collected and the collected data can be created for both the case of the “self-billing bill” and the case of the “negotiable bill.” In this manner, the information processing device 20 can function as an intermediary system between the “densai” system and the core system 30 such that the intermediary system provides information that is required by the core system 30 in a format that can be used by the core system 30. Consequently, the core system 30 can smoothly retrieve necessary information, and thereby management of the electronic credit can be facilitated.

[Collecting Electronic Credit Information for a Case of Multiple Providers]

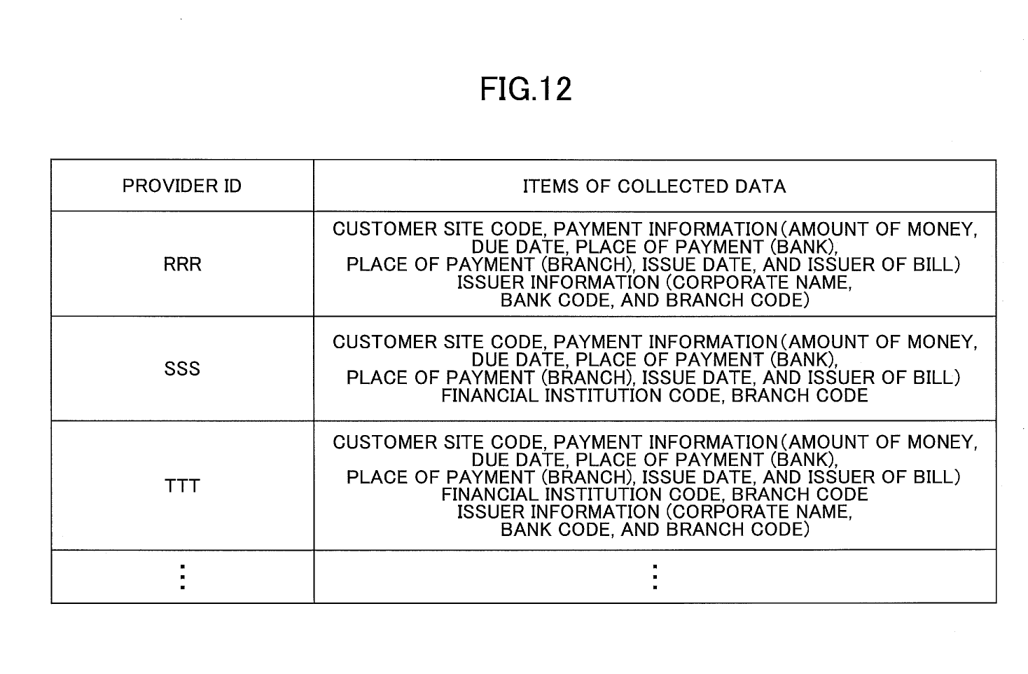

In the above-described embodiment, the process of collecting the electronic credit information is explained for the case of the single provider. Hereinafter, a case is explained in which there are multiple providers by referring to FIG. 12. FIG. 12 is a diagram showing an example of a list of provider IDs and data items to be collected according to an embodiment.

For a case of multiple providers as shown in the fields of the provider ID, items of the collected data may differ depending on a provider. Thus, the electronic credit server 10 can receive, from each of the providers, an advance notice regarding items of the collected data (items of the electronic credit collecting information) that are required for the provider. In response to the notice, the electronic credit server 10 stores, for each of the provider IDs, the items of the collected data that are to be collected for the provider in the list of the electronic credit collecting information.

For example, for a provider who is identified by the provider ID of “RRR,” the following data items can be specified as the items of the collected data that are desired to be collected from the “densai” system: the customer site code, “the amount of money,” “the due date,” “the place of payment (bank),” “the place of payment (branch),” “the issue date,” and “the issuer of the bill” of the payment information, the financial institution code, the branch code, and the issuer information (the corporate name, the bank code, and the branch code).

For a provider having a provider ID of “SSS,” the following data items can be specified as the data items that are desired to be collected from the “densai” system: the customer site code, “the amount of money,” “the due date,” “the place of payment (bank),” “the place of payment (branch),” “the issue date,” and “the issuer of the bill” of the payment.

For a provider having a provider ID of “TTT,” the following data items can be specified as the data items that are desired to be collected from the “densai” system: the customer site code, “the amount of money,” “the due date,” “the place of payment (bank),” “the place of payment (branch),” “the issue date,” and “the issuer of the bill” of the payment information, the financial institution code, the branch code, and the issuer information (the corporate name, the bank code, and the branch code). For example, depending on a provider, information on the issuer may be or may not be required.

The information processing device 20 can collect, based on the items of the collected data that are stored in the list, necessary information from the payment information that is received from the electronic credit server 1. By defining, in advance, the items of the collected data that are required for each of the providers, the electronic credit information collecting process (the electronic credit information collecting method) according to the embodiment can be executed for each of the providers, and thereby proper collection data that is defined for each of the providers can be provided.

### Modified Example

Note that, in the embodiment of the present invention, the electronic credit server 10 can be owned by a company X, the information processing device 20 and the core system 30 can be configured as a system that can be owned by a company Y that uses the electronic credit server 10, and in response to a request from the company Y, the company X can provide the information between the company X and the company Y (which includes the electronic credit information). However, in response to a request from the company Y, the electronic credit server 10 may access the storage unit 24 that is owned by the company Y, such as the customer master DB 42, the issuer master DB 43, and the retrieval history information DB 41; and the electronic credit server 10 may retrieve necessary information. In this case, the electronic server 10 may execute all or a part of the functions that are executed by the information processing device 20 in the above-described embodiment, such as the determining function, the comparing function, the retrieving function, the filtering function, and so forth. The information that is processed by the electronic credit server 10 may be transmitted to the receiver 22 of the information processing device 20, and the information that is processed by the electronic credit server 10 may be provided to the core system 30 through the providing unit 28. Here, instead of accessing the storage unit 24 that is owned by the company Y, such as the customer master DB 42, the issuer master DB 43, and the retrieval history information DB 41, a part of the information that is stored in these DBs may be transmitted to the electronic credit server 10 during transmission of the request from the company Y. After executing, by the electronic credit server 10 based on the part of the information, all or a part of the functions that are executed by the information processing device 20 in the above-described embodiment of the present invention, such as the determining function, the comparing function, the retrieving function, the filtering function, and so forth, the processed information may be transmitted to the receiver 22 of the information processing device 20.

(Example of Hardware Configuration)

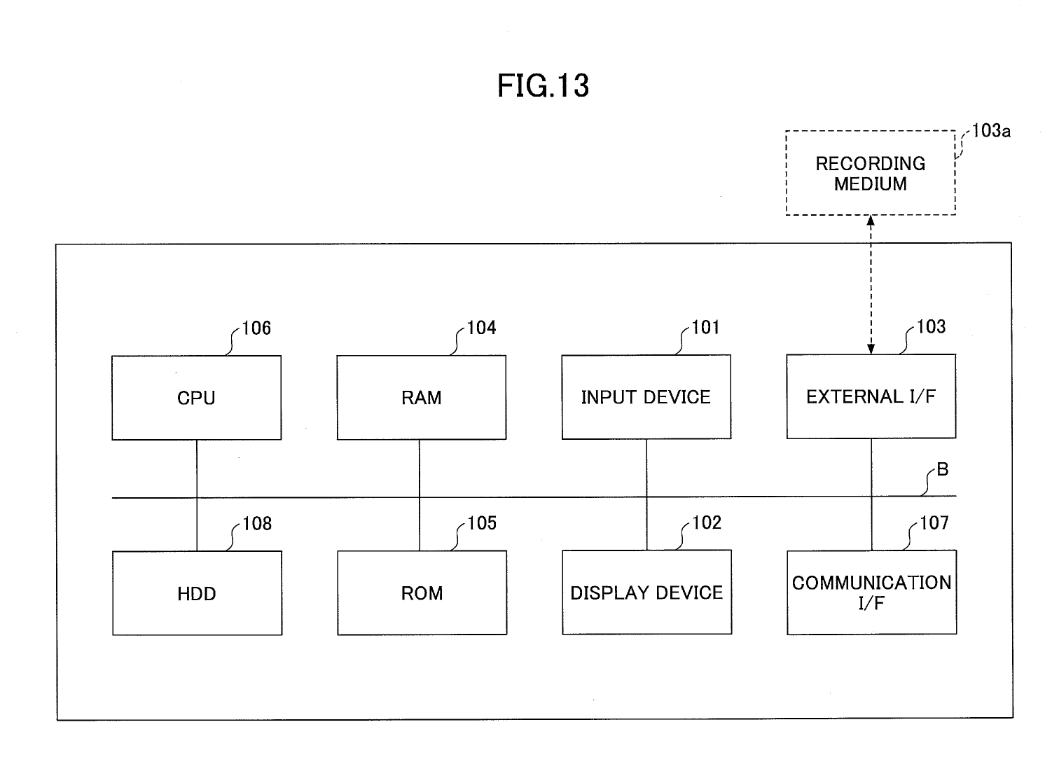

Finally, an example of hardware configurations of the information processing device 20 and the electronic credit server 10 according to the embodiment is described by referring to FIG. 13. FIG. 13 shows an example of the hardware configuration of the information processing device 20 according to the embodiment. In the following description, the example of the hardware configuration of the information processing device 20 is described. The description of the example of the hardware configuration of the electronic credit server 10 is omitted because the hardware configuration of the electronic credit server 10 can be the same as that of the information processing device 20.

The information processing device 20 may include an input device 101; a display device 102; an external interface (I/F) 103; a random access memory (RAM) 104; a read-only memory (ROM) 105; a central processing unit (CPU) 106; a communication interface (I/F) 107; and a hard disk drive (HDD) 108, and so forth. The above-described components can be mutually connected by a bus B.

The input device 101 may include a keyboard, a mouse, and so forth. The input device 101 can be used for inputting data to the information processing device 20. The display device 102 may include a display. The display device 102 can display various types of processing results.

The communication I/F 107 can be an interface for connecting the information processing device 20 to a network. By connecting the information processing device 20 to a network, the information processing device 20 can execute data communication with the electronic credit server 20 and the core system 30 through the communication I/F 107.

The HDD 108 can be a non-volatile storage device for storing a program and data. System software for controlling the entire device and application software can be an example of a program and data that can be stored in the HDD 108. For example, in the HDD 108, various types of databases and programs can be stored, such as the payment information DB 11, the retrieval history information DB 41, the customer master DB 42, and the issuer master DB 43.

The external I/F 103 can be an interface to an external device. A recording medium 103a can be an example of an external device. The information processing device 20 can read out data from the recording medium 103 and/or write data in the recording medium 103a through the external I/F 103. Examples of the recording medium 103a include a compact disk (CD); a digital versatile disk (DVD); a SD Memory card; a universal serial bus (USB) memory, and so forth.

The ROM 105 can be a non-volatile semiconductor memory (a storage device) that can maintain internal data even if a power supply is turned off. The ROM 105 can store a program and data, such as network setting. The RAM 104 can be a volatile semiconductor memory (a storage device) that can temporarily maintain a program and data. The CPU 106 can be a processor for controlling the entire device and for implementing functions of the device by reading out a program and data from the above-described storage devices (e.g., the HDD 108 and the ROM 105) onto the RAM 104, and by executing a process.

By the above-described hardware configuration, the information processing device 20 according to the embodiment can execute and manage the electronic credit information collecting process. For example, the CPU 106 can execute the electronic credit information collecting process by using data and a program that can be stored in the ROM 105 and the HDD 108. As a result, in the embodiment, the collected data that can be formed by including, in the electronic credit collecting information, the customer site code 428, and “the amount of money,” “the due date,” “the place of payment (bank),” “the place of payment (branch)” “the issue date,” and “the issuer of the bill” of the payment information can be provided to the core system 30 as the collection data. If the issuer master DB 43 exists, “the corporate name,” “the bank code,” and “the branch code” can further be set to “the issuer of the bill,” “the place of payment (bank),” and “the place of payment (branch),” respectively, and the collected data that includes “the corporate name,” “the bank code,” and “the branch code” can be provided to the core system 30 as the collection data.

Note that, the information regarding the payment information DB 11, the retrieval history information DB 41, the customer master DB 42, the issuer master DB 43 can be stored, for example, in the RAM 104, the HDD 108, or a cloud server that can be connected to the information processing device 20 through a network.

The information processing device, the electronic credit information collecting system, and the electronic credit information collecting method are explained by the above-described embodiment. However, the information processing device, the electronic credit information collecting system, and the electronic credit information collecting method according to the present invention are not limited to the above-described embodiment, and various modifications and improvements may be made within the scope of the present invention. Specific examples of numerical values are used in order to facilitate understanding of the invention. However, these numerical values are simply illustrative, and any other appropriate values may be used, except as indicated otherwise. The separations of the items in the above-described explanation are not essential to the present invention. Depending on necessity, subject matter described in two or more items may be combined and used, and subject matter described in an item may be applied to subject matter described in another item (provided that they do not contradict). A boundary of a functional unit or a processing unit in a functional block does not necessarily correspond to a boundary of a physical component. An operation by a plurality of functional units may be physically executed by a single component. Alternatively, an operation by a single functional unit may be physically executed by a plurality of components. For the convenience of explanation, the devices according to the embodiment of the present invention are explained by using the functional block diagrams. However, these devices may be implemented in hardware, software, or combinations thereof. The software that operates in accordance with the present invention may be prepared in any appropriate storage medium, such as a random access memory (RAM), a flash memory, read-only memory (ROM), an EPROM, an EEPROM, a register, a hard disk drive (HDD), a removable disk, a CD-ROM, a database, a server, and so forth.

The configuration of the electronic credit information collecting system according to the embodiment is for exemplifying purposes only, and the scope of the present invention is not limited to this. Depending on a use and/or a purpose, various system configurations can be considered.

The system configuration such that the electronic credit server 10, the information processing device 20, and the core system 30 are connected is one example of the electronic credit information collecting system according to the embodiment, and the electronic credit information collecting system according to the embodiment is not limited to this. For example, one or more electronic credit servers 10 and one or more information processing devices 20 can be included in the electronic credit information collecting system according to the embodiment.

The information processing device 20 and the core system 30 can be separated devices. Alternatively, an application program that can implement functions of the information processing device 20 can be installed in the core system 30, and the functions of the information processing device 20 can be implemented by the core system 30.

The present invention can be implemented in any convenient form, for example using dedicated hardware, or a mixture of dedicated hardware and software. The present invention may be implemented as computer software implemented by one or more network processing apparatuses. The network can comprise any conventional terrestrial or wireless communications network, such as the Internet. The processing apparatuses can compromise any suitable programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a CD ROM, a magnetic tape device or a solid state memory device. The hardware platform includes any desired hardware resources including, for example, a central processing unit (CPU), a random access memory (RAM), and a hard disk drive (HDD). The CPU may include processors of any desired kinds and numbers. The RAM may include any desired volatile or nonvolatile memories. The HDD may include any desired nonvolatile memories capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Priority Application No. 2014-217806 filed on Oct. 24, 2014, the entire contents of which are hereby incorporated herein by reference.

What is claimed is:

1. An information processing device configured to receive, from an electronic credit server, first payment information that includes electronic credit information, the information processing device comprising:
a determining unit configured to determine whether a registrant who registers the electronic credit information for a provider to the electronic credit server is same as an issuer who issues electronic credit, based on the first payment information that is transmitted from the electronic credit server;
a comparison unit configured to compare the first payment information with information that is stored in a customer master DB that stores customer information while switching a reference destination of the information that is stored in the customer master DB between a case in which the registrant is different from the issuer and a case in which the registrant is the same as the issuer, depending on a determination result by the determining unit;
a retrieval unit configured to retrieve, depending on a result of a comparison by the comparison unit, information on the registrant of the electronic credit based on the first payment information; and
a providing unit configured to provide, upon determining that the comparison by the comparison unit is successful, the information that is retrieved by the retrieval unit as electronic credit collecting information.

2. The information processing device according to claim 1,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

3. The information processing device according to claim 1, further comprising:
a filter unit configured to compare an electronic recording date that is included in the first payment information with a current date on which the electronic credit is to be processed, and configured to remove, out of the first payment information that is transmitted from the electronic credit server, second payment information that is not processed; and
a storage unit configured to store a first remainder of the first payment information in a retrieval history information DB, the first remainder of the first payment information being obtained by removing, by the filter unit, the second payment information that is not processed out of the first payment information that is transmitted from the electronic credit server,
wherein the retrieval unit is configured to retrieve information on the registrant of the electronic credit, based on the first remainder of the first payment information that is stored in the retrieval history information DB by the storage unit.

4. The information processing device according to claim 3,
wherein the filter unit is configured to remove, out of the first payment information that is transmitted from the electronic credit server, third payment information that overlaps fourth payment information other than the first remainder of the first payment information, the fourth payment information being stored in the retrieval history information DB, and
the storage unit is configured to store, in the retrieval history information DB, a second remainder of the first payment information, the second remainder of the first payment information being obtained by removing, out of the first payment information, the second payment information and the third payment information.

5. The information processing device according to claim 1,
wherein, in response to determining, by the determining unit, that the registrant is not the same as the issuer, the comparison unit is configured to compare issuer identification information with the first payment information, the issuer identification information being stored in an issuer master DB that stores issuer information, and
the retrieval unit is configured to retrieve the issuer identification information in accordance with a comparison result by the comparison unit.

6. The information processing device according to claim 1, further comprising:
a transmitter configured to transmit, in response to determining that the compared first payment information is the electronic credit that is used for a first time by a user who is identified by user identification information, a notification indicating that the first payment information is for an electronic credit transaction for the first time.

7. An electronic credit information collecting system comprising:
a determining unit configured to determine whether a registrant who registers electronic credit information for a provider to an electronic credit server configured to maintain the electronic credit information is same as an issuer who issues electronic credit, based on payment information including the electronic credit;
a comparison unit configured to compare the payment information with information that is stored in a customer master DB that stores customer information while switching a reference destination of the information that is stored in the customer master DB between a case in which the registrant is different from the issuer and a case in which the registrant is the same as the issuer, depending on a determination result by the determining unit;
a retrieval unit configured to retrieve, depending on a result of a comparison by the comparison unit, information on the registrant of the electronic credit based on the payment information; and
a providing unit configured to provide, upon determining that the comparison by the comparison unit is successful, the information that is retrieved by the retrieval unit as electronic credit collecting information.

8. An electronic credit information collecting method that is to be executed by a computer configured to receive payment information including electronic credit information from an electronic credit server, the method comprising:
a process, by the computer, of determining whether a registrant who registers the electronic credit information for a provider to the electronic credit server is same as an issuer who issues electronic credit, based on the payment information that is transmitted from the electronic credit server;
a process, by the computer, of comparing the payment information with information that is stored in a customer master DB that stores customer information while switching a reference destination of the information that is stored in the customer master DB between a case in which the registrant is different from the issuer and a case in which the registrant is the same as the issuer, depending on the determination result;
a process, by the computer, of retrieving, depending on the comparison result, information on the registrant of the electronic credit based on the payment information; and
a process, by the computer, of providing, upon determining that the comparison is successful, the information that is retrieved by the process of retrieving as electronic credit collecting information.

9. A non-transitory storage medium storing a program that causes a computer, the computer being configured to receive payment information including electronic credit information from an electronic credit server, to execute the method according to claim 8.

10. The electronic credit information collecting system according to claim 7, further comprising:
an electronic credit server including a transmitter configured to transmit, in response to a request from an information processing device, the payment information; and
the information processing device configured to receive the payment information that includes the electronic credit information from the electronic credit server, the information processing device including
a receiver configured to receive the payment information that is transmitted from the electronic credit server;
the determining unit;
the comparison unit;
the retrieval unit; and
the providing unit.

11. The electronic credit information collecting system according to claim 7, further comprising:
a storage unit configured to store, for each of a plurality of the providers, one or more information items that are to be retrieved from the payment information,
wherein the retrieval unit is configured to retrieve, depending on a comparison result by the comparison unit, the one or more information items that are stored for a requested provider.

12. The electronic credit information collecting system according to claim 10, further comprising:
a storage unit configured to store, for each of a plurality of the providers, one or more information items that are to be retrieved from the payment information,
wherein the retrieval unit is configured to retrieve, depending on a comparison result by the comparison unit, the one or more information items that are stored for a requested provider.

13. The information processing device according to claim 1, further comprising:
a filter unit configured to compare an electronic recording date that is included in the payment information with a current date on which the electronic credit is to be processed, and configured to remove, out of the first payment information that is transmitted from the electronic credit server, second payment information that is not processed; and
a storage unit configured to store a first remainder of the first payment information in a retrieval history information DB, the first remainder of the first payment information being obtained by removing, by the filter unit, the second payment information that is not processed, out of the first payment information that is transmitted from the electronic credit server,
wherein the retrieval unit is configured to retrieve information on the registrant of the electronic credit, based on the first remainder of the first payment information that is stored in the retrieval history information DB by the storage unit, and
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

14. The information processing device according to claim 1, further comprising:
a filter unit configured to remove, out of the first payment information that is transmitted from the electronic credit server, third payment information that overlaps fourth payment information other than the first remainder of the first payment information, the fourth payment information being stored in the retrieval history information DB, and
a storage unit configured to store, in the retrieval history information DB, a second remainder of the first payment information, the second remainder of the first payment information being obtained by removing, out of the first payment information, second payment information that is not processed and the third payment information,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

15. The information processing device according to claim 1,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB, and configured to compare issuer identification information with the first payment information, the issuer identification information being stored in an issuer master DB that stores issuer information, and
the retrieval unit is configured to retrieve the issuer identification information in accordance with a comparison result by the comparison unit.

16. The information processing device according to claim 1, further comprising:
a transmitter configured to transmit, in response to determining that the compared first payment information is the electronic credit that is used for a first time by a user who is identified by user identification information, a notification indicating that the first payment information is for an electronic credit transaction for the first time,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

17. The information processing device according to claim 1, further comprising:
a filter unit configured to compare an electronic recording date that is included in the first payment information with a current date on which the electronic credit is to be processed, configured to remove, out of the first payment information that is transmitted from the electronic credit server, second payment information that is not processed, and configured to remove, out of the first payment information that is transmitted from the electronic credit server, third payment information that overlaps fourth payment information other than a first remainder of the first payment information, the first remainder of the first payment information being obtained by removing, out of the first payment information, the second payment information, and the fourth payment information being stored in a retrieval history information DB; and
a storage unit configured to store, in the retrieval history information DB, a second remainder of the first payment information, the second remainder of the first payment information being obtained by removing, out of the first payment information, the second payment information and the third payment information,
wherein the retrieval unit is configured to retrieve information on the registrant of the electronic credit, based on the first remainder of the first payment information,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

18. The information processing device according to claim 1, further comprising:
a filter, unit configured to compare an electronic recording date that is included in the payment information with a current date on which the electronic credit is to be processed, and configured to remove, out of the first payment information that is transmitted from the electronic credit server, second payment information that is not processed; and
a storage unit configured to store a first remainder of the first payment information in a retrieval history information DB, the first remainder of the first payment information being obtained by removing, by the filter unit, the second payment information that is not processed out of the first payment information that is transmitted from the electronic credit server,
wherein the retrieval unit is configured to retrieve information on the registrant of the electronic credit, based on the first remainder of the first payment information that is stored in the retrieval history information DB by the storage unit,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB, and configured to compare issuer identification information with the first payment information, the issuer identification information being stored in an issuer master DB that stores issuer information, and
the retrieval unit is configured to retrieve the issuer identification information in accordance with a comparison result by the comparison unit.

19. The information processing device according to claim 1, further comprising:
a filter unit configured to compare an electronic recording date that is included in the payment information with a current date on which the electronic credit is to be processed, and configured to remove, out of the first payment information that is transmitted from the electronic credit server, second payment information that is not processed;
a storage unit configured to store a first remainder of the first payment information in a retrieval history information DB, the first remainder of the first payment information being obtained by removing, by the filter unit, the second payment information that is not processed out of the first payment information that is transmitted from the electronic credit server; and
a transmitter configured to transmit, in response to determining that the compared first payment information is the electronic credit that is used for a first time by a user who is identified by user identification information, a notification indicating that the first payment information is for an electronic credit transaction for the first time,
wherein the retrieval unit is configured to retrieve information on the registrant of the electronic credit, based on the first remainder of the first payment information that is stored in the retrieval history information DB by the storage unit,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB.

20. The information processing device according to claim 1, further comprising:
a filter unit configured to compare an electronic recording date that is included in the payment information with a current date on which the electronic credit is to be processed, configured to remove, out of the first payment information that is transmitted from the electronic credit server, second payment information that is not processed, and configured to remove, out of the first payment information that is transmitted from the electronic credit server, third payment information that overlaps fourth payment information other than a first remainder of the first payment information, the first remainder of the first payment information being obtained by removing, out of the first payment information, the second payment information, and the fourth payment information being stored in a retrieval history information DB; and
a storage unit configured to store, in the retrieval history information DB, a second remainder of the first payment information, the second remainder of the first payment information being obtained by removing, out of the first payment information, the second payment information and the third payment information,
wherein the retrieval unit is configured to retrieve information on the registrant of the electronic credit, based on the first remainder of the first payment,
wherein, in response to determining, by the determining unit, that the registrant is the same as the issuer, the comparison unit is configured to compare user identification information for each of customers with the first payment information, the user identification information for each of the customers being stored in the customer master DB, and
in response to determining, by the determining unit, that the registrant is not the same as the issuer, the comparison unit is configured to compare bank identification information for each of the customers with the first payment information, the bank identification information for each of the customers being stored in the customer master DB, and configured to compare issuer identification information with the first payment information, the issuer identification information being stored in an issuer master DB that stores issuer information, and
the retrieval unit is configured to retrieve the issuer identification information in accordance with a comparison result by the comparison unit.
